(19) United States
(12) Patent Application Publication
(10) Pub. No.: US 2016/0018575 A1
(43) Pub. Date: Jan. 21, 2016

(54) COLOR FILTER AND FABRICATING METHOD THEREOF, AND DISPLAY APPARATUS

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Changdi CHEN, Beijing (CN); Xiangwan LU, Beijing (CN); Yiyong LUO, Beijing (CN); Tao YANG, Beijing (CN)

(21) Appl. No.: 14/430,024

(22) PCT Filed: Jun. 30, 2014
(86) PCT No.: PCT/CN2014/081135

§ 371 Date: Mar. 20, 2015

(30) Foreign Application Priority Data
Dec. 17, 2013 (CN) 201310700382.4

(51) Int. Cl. G02B 5/20

(52) U.S. Cl. CPC G02B 5/201

(57) ABSTRACT

A color filter and a fabricating method thereof, and a display apparatus are provided. The color filter includes: at least four pixel units, and each pixel unit includes a color filter layer, and the four pixel units are a first pixel unit, a second pixel unit, a third pixel unit and a fourth pixel unit, respectively. A first color filter layer is formed in the first pixel unit, a second color filter layer is formed in the second pixel unit, a third color filter layer is formed in the third pixel unit, a fourth color filter layer is formed in the fourth pixel unit, and the fourth color filter layer is formed by stacking any two materials of the first, second and third color filter layers.

### TECHNICAL FIELD

Embodiments of the present invention relate to a field of display technology, and in particular, to a color filter and a fabricating method thereof, and a display apparatus.

### BACKGROUND

As an apparatus for displaying color image, a display apparatus has the ability of color reproduction, and the color gamut is its main performance index. The higher is the color gamut of the display apparatus, the higher is the ability of the display apparatus to reproduce color, otherwise, the ability of the display apparatus to reproduce color is lower. Currently, every manufacturer pursues a display apparatus having a high gamut.

The color gamut is a representation scope of color. Generally, the color gamut of the color display apparatus is an area of a primary color triangle constituted by three primary colors in a chromaticity diagram.

The color gamut of the existing display apparatus is mainly determined by a color filter. As illustrated in FIG. 1, one pixel region 100 of the existing color filter comprises pixel regions R, G and B corresponding to three primary colors (red, green and blue), and each pixel region corresponds to a color filter layer of one color. The color gamut of the display apparatus is mainly determined by the area of the triangle constituted by chromaticity coordinates of three primary colors (red, green and blue), and the color gamut is relatively small.

In the prior art, the color gamut of the display apparatus is improved by the following manner: one implementing manner is to manufacture a color filter by using quantum dot material, but the cost of the quantum dot material is relatively high than that of the commonly used photoresist material, and it is disadvantage to achieve a display apparatus having a low cost and a high performance; another implementing manner is that the backlight source uses three kinds of backlight diode (LED), red, green and blue, however, such design manner would increase the cost of the backlight source, and it is also disadvantage to achieve a display apparatus having a low cost and a high performance.

### SUMMARY

Embodiments of the present invention provide a color filter and a fabricating method thereof, and a display apparatus, and the color filter provided by the embodiment of the present invention may achieve a display apparatus having a larger color gamut.

An embodiment of the present invention provides a color filter, and each pixel region of the color filter comprises at least four pixel units, each pixel unit comprises a color filter layer, and the at least four pixel units comprise a first pixel unit, a second pixel unit, a third pixel unit and a fourth pixel unit, wherein a first color filter layer is formed in the first pixel unit, a second color filter layer is formed in the second pixel unit, a third color filter layer is formed in the third pixel unit, a fourth color filter layer is formed in the fourth pixel unit, and the fourth color filter layer is formed by stacking any two materials of the first, second and third color filter layers.

In at least one embodiment, the two materials in the fourth color filter layer may have the same thickness.

In at least one embodiment, a thickness of the fourth color filter layer may be the same as a thickness of at least one of the first, second and third color filter layers.

In at least one embodiment, the fourth color filter layer may be a cyan filter layer, the first color filter layer may be a red filter layer, the second color filter layer may be a green filter layer, the third color filter layer may be a blue filter layer, and the cyan filter layer may be formed by stacking the green filter layer material and the blue filter layer material.

In at least one embodiment, the fourth color filter layer may be a yellow filter layer, the first color filter layer may be a red filter layer, the second color filter layer may be a green filter layer, the third color filter layer may be a blue filter layer, and the yellow filter layer may be formed by stacking the red filter layer material and the green filter layer material.

In at least one embodiment, the fourth color filter layer may be a magenta filter layer, the first color filter layer may be a red filter layer, the second color filter layer may be a green filter layer, the third color filter layer may be a blue filter layer, and the magenta filter layer may be formed by stacking the red filter layer material and the blue filter layer material.

An embodiment of the present invention further provides a display apparatus, which comprises any one color filter described above.

An embodiment of the present invention further provides a method of fabricating a color filter, each pixel region of the color filter comprises at least four pixel units, each pixel unit comprises a color filter layer, and the at least four pixel units comprise a first pixel unit, a second pixel unit, a third pixel unit and a fourth pixel unit, and the fabricating method may comprise: forming a first color filter layer, a second color filter layer, a third color filter layer and a fourth color filter layer in the first pixel unit, the second pixel unit, the third pixel unit and the fourth pixel unit, respectively, wherein the fourth color filter layer is formed by stacking any two materials of the first, second and third color filter layers.

In at least one embodiment, the fourth color filter layer may be formed by stacking film layers having the same thickness and formed by any two materials of the first, second and third color filter layers.

In at least one embodiment, a thickness of the fourth color filter layer may be the same as a thickness of at least one of the first, second and three color filter layers.

In at least one embodiment, forming the first color filter layer, the second color filter layer, the third color filter layer and the fourth color filter layer may comprise: forming a red filter layer in a region corresponding to the first pixel unit; forming a green filter layer in a region corresponding to the second and fourth pixel units; forming a blue filter layer in a region corresponding to the third and fourth pixel units, so that the region corresponding to the fourth pixel unit is formed by stacking the green filter layer and the blue filter layer.

In at least one embodiment, forming the first color filter layer, the second color filter layer, the third color filter layer and the fourth color filter layer may comprise: forming a red filter layer in a region corresponding to the first pixel unit and the fourth pixel unit; forming a green filter layer in a region corresponding to the second and fourth pixel units, so that the region corresponding to the fourth pixel unit is formed by stacking the green filter layer and the red filter layer; and forming a blue filter layer in a region corresponding to the third pixel unit.

In at least one embodiment, forming the first color filter layer, the second color filter layer, the third color filter layer and the fourth color filter layer may comprise: forming a red filter layer in a region corresponding to the first pixel unit and the fourth pixel unit; forming a green filter layer in a region corresponding to the second pixel unit; and forming a blue filter layer in a region corresponding to the third pixel unit and the fourth pixel unit, so that the region corresponding to the fourth pixel unit is formed by stacking the blue filter layer and the red filter layer.

In at least one embodiment, the first to third color filter layers may be formed through a full-tone region of a mask plate, and the fourth color filter layer may be formed through a half-tone region of the mask plate.

To sum up, the embodiments of the present invention provide a color filter, and each pixel region of the color filter comprises at least four pixel units, each pixel unit comprises a color filter layer, and the at least four pixel units comprise a first pixel unit, a second pixel unit, a third pixel unit and a fourth pixel unit, wherein a first color filter layer is formed in the first pixel unit, a second color filter layer is formed in the second pixel unit, a third color filter layer is formed in the third pixel unit, a fourth color filter layer is formed in the fourth pixel unit, and the fourth color filter layer is formed by stacking any two materials of the first, second and third color filter layers. Compared with the existing pixel region constituted by using three primary color pixels, the embodiments of the present invention may effectively improve color gamut of the display apparatus.

### BRIEF DESCRIPTION OF DRAWINGS

FIG. 1 is a structural schematic view of color filter layers of one pixel region of an existing color filter;

FIG. 2 is a structural schematic view of a pixel region provided by an embodiment of the present invention;

FIG. 3 is a structural schematic view of color filter layers arranged in the pixel region provided by FIG. 2;

FIG. 4 is a structural schematic view of color filter layers arranged in a pixel region according to another embodiment of the present invention;

FIG. 5 is a structural schematic view of color filter layers arranged in a pixel region according to another embodiment of the present invention;

FIG. 6 is a structural schematic view of a color filter substrate during an intermediate process step in a fabricating method according to an embodiment of the present invention; and

FIG. 7 is a structural schematic view of a color filter substrate during an intermediate process step in a fabricating method according to an embodiment of the present invention.

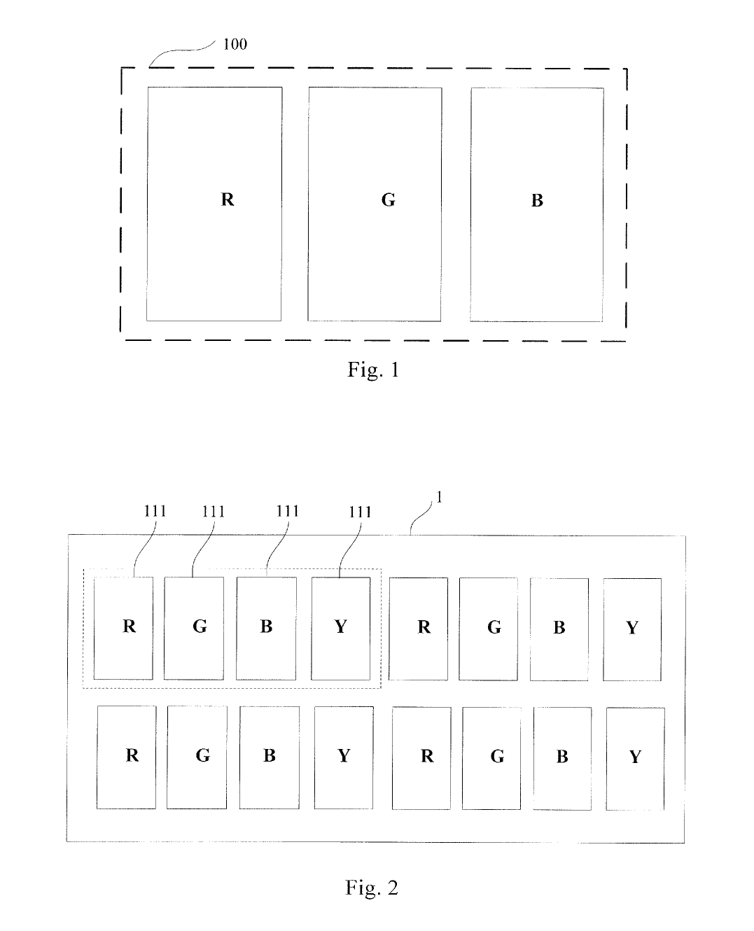

### DETAILED DESCRIPTION

The embodiments of the present invention provide a color filter and a fabricating method thereof, and a display apparatus, and a display apparatus having a larger color gamut may be achieved by using the color filter provided by the embodiments of the present invention.

Compared with the existing pixel region constituted by using three primary color pixels, the embodiments of the present invention effectively improve color gamut of the display apparatus by arranging pixel units having at least four colors and arranging a color filter layer of one color in each pixel unit.

Here, a pixel, in which the color obtained after a white light is filtered is red, is defined as a red pixel unit; a pixel, in which the color obtained after a white light is filtered is green, is defined as a green pixel unit; a pixel, in which the color obtained after a white light is filtered is blue, is defined as a blue pixel unit; a pixel, in which the color obtained after a white light is filtered is cyan, is defined as a cyan pixel unit; a pixel, in which the color obtained after a white light is filtered is yellow, is defined as a yellow pixel unit; and a pixel, in which the color obtained after a white light is filtered is magenta, is defined as a magenta pixel unit.

The color filter, a fabricating method thereof and a display apparatus provided by the embodiments of the present invention will be described in detail below in combination with the drawings.

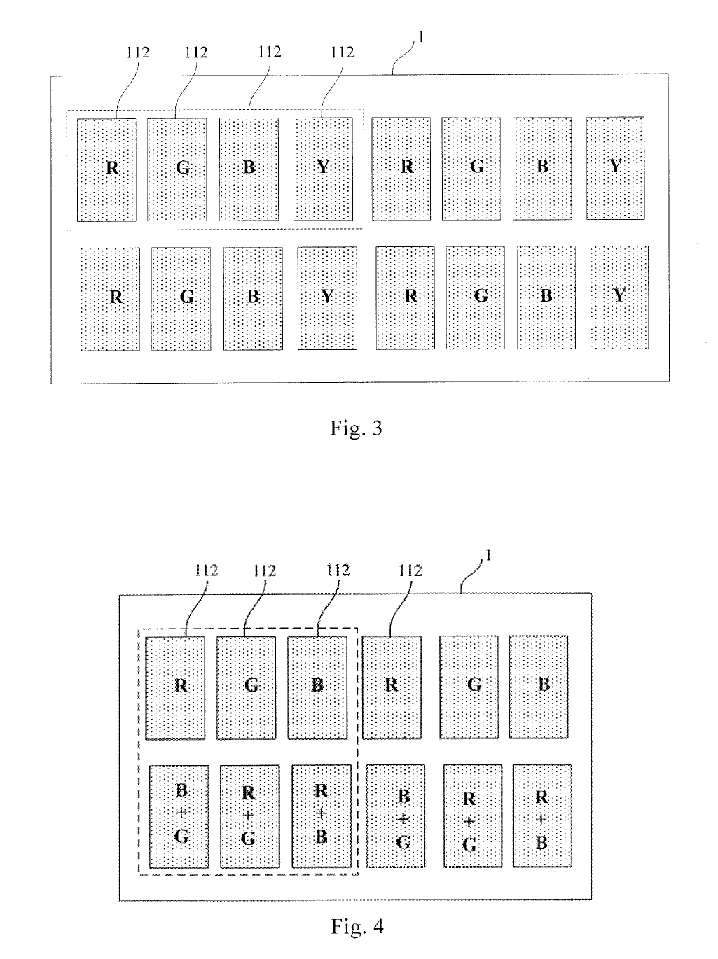

Referring to FIGS. 2 and 3, a color filter provided by an embodiment of the present invention may comprise at least four pixel units 111 located on a base substrate 1, and each pixel unit 111 comprises a color filter layer 112. The four pixel units are a first pixel unit, a second pixel unit, a third pixel unit and a fourth pixel unit, respectively, and a first color filter layer is formed in the first pixel unit, a second color filter layer is formed in the second pixel unit, a third color filter layer is formed in the third pixel unit, a fourth color filter layer is formed in the fourth pixel unit. The fourth color filter layer may be formed by stacking any two materials of the first, second and third color filter layers.

FIG. 2 only illustrates four pixel units 111 on the base substrate 1. FIG. 2 only illustrates one embodiment of the above embodiments, and each pixel region may comprise four pixel units 111 on the base substrate 1, wherein the first pixel unit is a red pixel unit (R), the second pixel unit is a green pixel unit (G), the third pixel unit is a blue pixel unit (B), the fourth pixel unit is a magenta pixel unit (Y). The fourth pixel unit may be not defined to the magenta pixel unit (Y), and alternatively, it may be a yellow pixel unit, a cyan pixel unit, or the like.

FIG. 3 only illustrates the color filter layers located in each pixel unit. Specifically, FIG. 3 illustrates: a red filter layer located in the red pixel unit (R), a green filter layer located in the green pixel unit (G), a blue filter layer located in the blue pixel unit (B), and a film layer formed by stacking the red filter layer material and the blue filter layer material in the magenta pixel unit (Y).

In the color filter provided by the above embodiment, each pixel region may be disposed with color filter layers of at least four colors, and the formed color gamut of the display apparatus may be determined by the area of the chromaticity coordinates of four colors. Since the area formed by the area of the chromaticity coordinates of four colors is larger than the area of the triangle formed by the chromaticity coordinates of three primary colors, the color gamut of the display apparatus may be improved.

In the color filter provided by the above embodiment, each pixel region may comprise color filter layers of four colors, color filter layers of five colors, or color filters of six colors, or color filter layers of more colors. It is emphasized again that, the color filter layers of four colors, color filter layers of five colors, or color filters of six colors described above or below in the present invention refer to color filter layers in which the kinds of colors obtained after the white light is filtered are four, five or six, and each color corresponds to one color filter layer.

Alternatively, two materials in the fourth color filter layer may have the same thickness.

Further, a thickness of the fourth color filter layer may be the same as that of at least one of the first, second and three color filter layers.

In an embodiment, among the color filter layers of four colors, the first color filter layer may be a red filter layer (R), the second color filter layer may be a green filter layer (G), the third color filter layer may be a blue filter layer (B), and the fourth color filter layer may be a cyan filter layer (C).

The fourth color filter layer may be not limited to the cyan filter layer (C). Alternatively, the fourth color filter layer may be a magenta filter layer (M) or a yellow filter layer (Y).

When the first color filter layer, the second color filter layer and the third color filter layer are a red filter layer (R), a green filter layer (G) and a blue filter layer (B), respectively, the color filter layer formed by stacking any two materials of the red filter layer (R), the green filter layer (G) and the blue filter layer (B) is more close to the cyan filter layer (C), the magenta filter layer (M) or the yellow filter layer (Y), if the two materials have the same thickness; since the color obtained by being filtered by the cyan filter layer (C), the magenta filter layer (M) or the yellow filter layer (Y) also belongs to a primary color, the color image having a better effect may be achieved. If the thickness of the fourth color filter layer is the same as that of at least one of the first color filter layer, the second color filter layer and the third color filter layer, the effect of displaying color image and the transmittance of the light are relatively consistent, and the quality of the image is further improved.

Each pixel region 11 illustrated in FIG. 3 may comprise a red filter layer (R), a green filter layer (G), a blue filter layer (B) and a yellow filter layer (Y), and the relative positions of the red filter layer (R), the green filter layer (G), the blue filter layer (B) and the yellow filter layer (Y) may be not limited to that illustrated in FIG. 3. FIG. 3 is only used to explain an embodiment of the present invention, and is not intended to limit the present invention.

The red filter layer, the green filter layer and the blue filter layer may be formed by a red photoresist material, a green photoresist material and a blue photoresist material, respectively, and these three photoresist materials are commonly used photoresist materials and have a relatively low cost, and their implementing procedure are relatively easy.

There are at least two manners to form the cyan filter layer (C), the yellow filter layer (Y) or the magenta filter layer (M).

One implementing manner is that: as illustrated in FIG. 4, the cyan filter layer (C) is formed by a blue photoresist material and a green photoresist material; the yellow filter layer (Y) is formed by a red photoresist material and a green photoresist material; and the magenta filter layer (M) is formed by a red photoresist material and a blue photoresist layer.

Another implementing manner is that: the cyan filter layer (C) is formed by a cyan photoresist material; the yellow filter layer (Y) is formed by a yellow photoresist material; and a magenta filter layer (M) is formed by a magenta photoresist material.

In other words, the fourth color filter layer may be a cyan filter layer, the first color filter layer may be a red filter layer, the second color filter layer may be a green filter layer, the third color filter layer may be a blue filter layer, and the cyan filter layer may be formed by stacking the green filter layer material and the blue filter layer material.

Alternatively, the fourth color filter layer may be a yellow filter layer, the first color filter layer may be a red filter layer, the second color filter layer may be a green filter layer, the third color filter layer may be a blue filter layer, and the yellow filter layer may be formed by stacking the red filter layer material and the green filter layer material.

Alternatively, the fourth color filter layer may be a magenta filter layer, the first color filter layer may be a red filter layer, the second color filter layer may be a green filter layer, the third color filter layer may be a blue filter layer, and the magenta filter layer may be formed by stacking the red filter layer material and the blue filter layer material.

For the color filter layers as illustrated in FIG. 4, the respective color filter layers are formed by commonly used red photoresist material, green photoresist material and blue photoresist material, and the color gamut of the display apparatus is improved without increasing the cost of the color filter.

In FIG. 4, “B+G” indicates that the cyan filter layer (C) formed by combining the blue photoresist material and the green photoresist material; “R+G” represents the yellow filter layer (Y) formed by combining the red photoresist material and the green photoresist material; and “R+B” represents the magenta filter layer (M) formed by combining the red photoresist material and the blue photoresist material.

The above embodiments are explained with respect to the case that each pixel region comprises color filter layers of four colors, and of course the color filters provided by the embodiments of the present invention are not limited to the color filters only comprising four colors. As illustrated in FIG. 4, each pixel region may comprise color filter layers 112 of six colors.

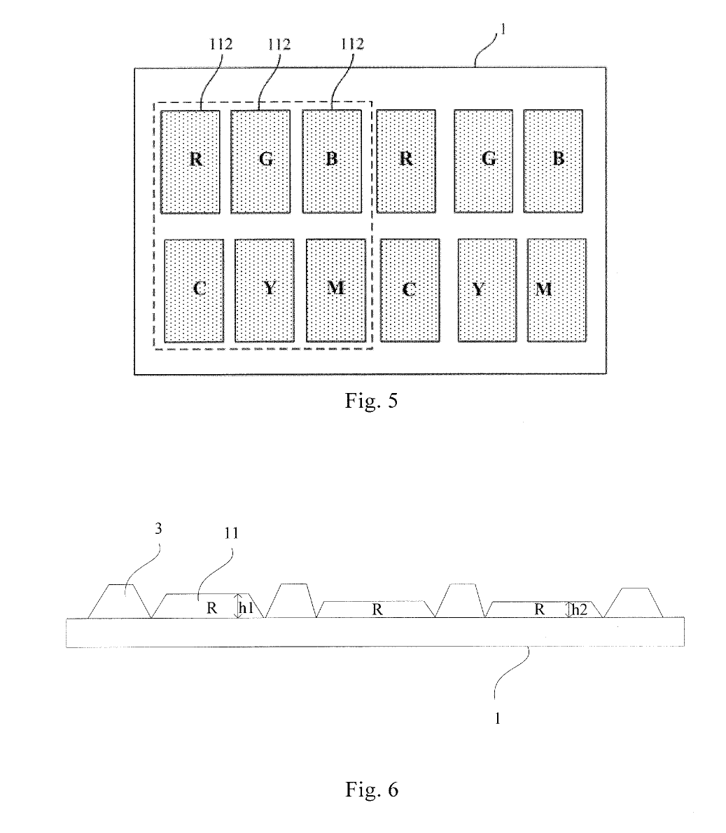

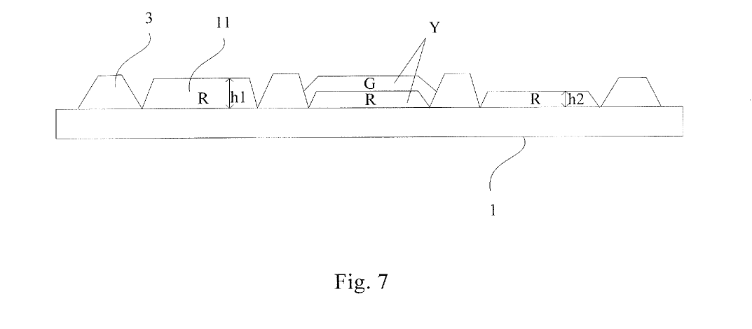

Referring to FIG. 5, alternatively, each pixel region may comprise a red filter film (R), a green filter film (G), a blue filter film (B), a cyan filter film (C), a yellow filter film (Y), and a magenta filter film (M).

The relative positions of the red filter film (R), the green filter film (G), the blue filter film (B), the cyan filter film (C), the yellow filter film (Y), and the magenta filter film (M) may be not limited to that illustrated in the figure.

When implementing in detail, the pixel region corresponding to the above color filter layers of four colors or six colors may be irradiated by using a backlight source emitting white light, and the white light is being filtered, to achieve luminous displaying of the corresponding color. On one hand, the backlight source emitting white light is of a relatively mature technology and has a lower cost, compared with the backlight source emitting red, green or blue light. On the other hand, by using the color filter layers corresponding to three primary colors R, G and B comprising a higher color saturation, the displaying quality of the image is higher; meantime, by using the pixel region constituted by a cyan (C), yellow (Y) or magenta (M) color filter layer, when the white light irradiates the pixel region, the white light is divided into light of four colors or six colors, and the color gamut of the display apparatus is higher than the pixel constituted by three primary colors. In addition, the costs of the R, G and B photoresists and cyan (C), yellow (Y) and magenta (M) photoresists constituting the color filter layers are lower than that of the existing color filter manufactured by using quantum dot material, and it is more advantageous to achieve a color filter having a low cost and a high performance, and the display apparatus comprising the color filter.

An embodiment of the present invention further provides a display apparatus, which comprises the above described color filter.

The display apparatus may be a liquid crystal display panel, an organic light emitting display panel, a display, or the like. The color filter may be disposed on a color filter substrate or an array substrate of the display apparatus.

When the color filter is applied in the color filter substrate in the display panel, the display apparatus may further comprise a black matrix, which may be located in a non-display region between the adjacent color filter layers.

In particular, when the color filter is applied in the color filter substrate in the display panel, the respective color filter layers in the color filter may be located in a region surrounded by the black matrix, and the black matrix may be located in the non-display region between the color filter layers.

The fabricating method of the color filter provided by the embodiments of the present invention will be described below in detail.

The fabricating method of the color filter may generally comprise the following steps:

forming a first color filter layer, a second color filter layer, a third color filter layer and a fourth color filter layer in a first pixel unit, a second pixel unit, a third pixel unit and a fourth pixel unit, respectively, wherein the fourth color filter layer may be formed by stacking film layers formed of any two materials of the first, second and third color filter layers.

Alternatively, the fourth color filter layer may be formed by stacking film layers having the same thickness formed of any two materials of the first, second and third color filter layers.

Alternatively, a thickness of the fourth color filter layer may be the same as a thickness of at least one of the first, second and three color filter layers.

Here, forming color filter layers of four colors is taken as an example to explain. Forming the first color filter layer, the second color filter layer, the third color filter layer and the fourth color filter layer may comprise:

forming a red filter layer in a region corresponding to the first pixel unit;

forming a green filter layer in a region corresponding to the second and fourth pixel units;

forming a blue filter layer in a region corresponding to the third and fourth pixel units, so that the region corresponding to the fourth pixel unit is formed by stacking the green filter layer and the blue filter layer.

Alternatively, forming a first color filter layer, a second color filter layer, a third color filter layer and a fourth color filter layer may comprise:

forming a red filter layer in a region corresponding to the first pixel unit and the fourth pixel unit;

forming a green filter layer in a region corresponding to the second and fourth pixel units, so that the region corresponding to the fourth pixel unit is formed by stacking the green filter layer and the red filter layer; and

forming a blue filter layer in a region corresponding to the third pixel unit.

Alternatively, forming a first color filter layer, a second color filter layer, a third color filter layer and a fourth color filter layer may comprise:

forming a red filter layer in a region corresponding to the first pixel unit and the fourth pixel unit;

forming a green filter layer in a region corresponding to the second pixel unit; and

forming a blue filter layer in a region corresponding to the third pixel unit and the fourth pixel unit, so that the region corresponding to the fourth pixel unit is formed by stacking the blue filter layer and the red filter layer.

The red filter layer, the green filter layer and the blue filter layer may be formed by a red photoresist material, a green photoresist material and a blue photoresist material, respectively. The cyan filter layer (C) may be formed by a blue photoresist material and a green photoresist material; the yellow filter layer (Y) may be formed by a red photoresist material and a green photoresist material; and the magenta filter layer (M) may be formed by a red photoresist material and a blue photoresist layer.

Further, a film layer formed by the red photoresist material in the red pixel region and the yellow pixel region is completed in the same patterning process; the film layer formed by red photoresist material in the red pixel region and the magenta pixel region is completed in the same patterning process;

wherein, a full-tone mask plate is used in the red pixel region, and a half-tone mask plate is used in the yellow pixel region and the magenta pixel region, so that the thickness of the photoresist layer corresponding to the full-tone mask plate is two times of the thickness of the photoresist layer corresponding to the half-tone mask plate.

In particular, a red photoresist layer is formed on a base substrate and covers the entire base substrate, and exposing is performed on the red photoresist layer by a BGR mask plate. Generally, the photoresist (i.e. color resin) to fabricate the color filter is a negative photoresist, and the region irradiated by light remains and the region not irradiated is removed by an etching solution. In order to achieve that the thickness of the photoresist layer corresponding to the full-tone mask plate is two times of the thickness of the photoresist layer corresponding to the half-tone mask plate, the mask plate should satisfy the following requirements:

a region of the mask plate corresponding to the red pixel region is the full-tone mask plate, and a region of the mask plate corresponding to the yellow pixel region and the magenta pixel region is the half-tone mask plate. The light transmittance of the full-tone mask plate is 100%, and the light transmittance of the half-tone mask plate is 50%, so the former is two times of the latter, and the thicknesses of the photoresist film layer in the red pixel region is two times of that in the yellow pixel region or the magenta pixel region.

The green photoresist layer in the green pixel region and the cyan pixel region is completed in the same patterning process, and the green photoresist layer in the green pixel region and the yellow pixel region is completed in the same patterning process, wherein, a full-tone mask plate is used in the green pixel region, and a half-tone mask plate is used in the cyan pixel region and the yellow pixel region, so that the thickness of the photoresist layer corresponding to the full-tone mask plate is two times of the thickness of the photoresist layer corresponding to the half-tone mask plate; in particular, on the basis of the above formed red photoresist layer, the green photoresist layer is formed in the green pixel region, the cyan pixel region and the yellow pixel region; the forming procedure is similar to the above procedure of forming the red photoresist layer, and at this time, the mask plate satisfies: a region of the mask plate corresponding to the green pixel region is the full-tone mask plate, and a region of the mask plate corresponding to the cyan pixel region and the yellow pixel region is the half-tone mask plate. At this time, the photoresist layers in the red pixel region, the green pixel region and the yellow pixel regions have been completely formed.

The blue photoresist layer in the blue pixel region, cyan pixel region and the magenta pixel region is completed in the same patterning process, wherein, a full-tone mask plate is used in the blue pixel region, and a half-tone mask plate is used in the cyan pixel region and the magenta pixel region, so that the thickness of the photoresist layer corresponding to the full-tone mask plate is two times of the thickness of the photoresist layer corresponding to the half-tone mask plate;

In particular, on the basis of the above formed green photoresist layer, a blue photoresist layer is formed in the blue pixel region, the cyan pixel region and the magenta pixel region;

the forming procedure is similar to the above procedure of forming the green photoresist layer, and at this time, the mask plate satisfies: a region of the mask plate corresponding to the blue pixel region is the full-tone mask plate, and a region of the mask plate corresponding to the cyan pixel region and the magenta pixel region is the half-tone mask plate. At this time, the photoresist layers in the blue pixel region, the cyan pixel region and the magenta pixel regions have been completely formed.

The forming sequence of the above three steps for forming various color filter layers may be not limited thereto, and the above implementing manner is only one embodiment, only used to explain the embodiment of the present invention and is not intended to limit the present invention.

If the color filter is used for the color filter substrate, the fabricating method of the color filter substrate may comprise: a fabricating procedure of a black matrix and a fabricating procedure of a color filter layer.

The sequence of the fabricating procedures of the black matrix and the color filter layer may be not redistricted.

Alternatively, referring to FIG. 6, a black matrix 3 is first formed on a base substrate 1 by an exposing process; then color filter layers 11 of various colors are formed on the base substrate 1 formed with the black matrix 3.

A cyan filter layer, a yellow filter layer and a magenta filter layer may be formed by two photoresist materials, and any one photoresist of the two photoresists may be a red, green or blue photoresist.

During the design of the mask plate, full-tone (mask grid of 100% transmittance) and half-tone (mask grid of 50% transmittance) are alternately used for pixels of each color.

A film layer stacked by photoresists of two colors is formed in the corresponding half-tone pixel region, and the stacking manner has three combinations (B+R), (B+G), and (R+G).

The three BGR color filters are formed by exposing process, and since the transmittance of the half-tone mask is half of that of the full-tone mask, the thickness of the formed BGR film is half of that designed for the full tone. In this way, the film thickness of the formed three combinations (B+R), (B+G), and (R+G) may be the same as the individual BGR film thickness of the full tone.

It needs three exposing processes in total to form the color filter layers of six colors.

Referring to FIG. 6, every exposing may form a photoresist layer having a thickness h1 corresponding to the full-tone region on the mask plate, and a photoresist layer having a thickness h2 corresponding to the half-tone region on the mask plate, wherein h1=2h2.

The film layer formed by two times of exposing in the half-tone region on the mask plate is to further form a green photoresist having a thickness h2 on a region having a thickness h2, and the color filter layer constituted by the region is the yellow filter layer Y. The formation of other color filter layers is not described here one by one.

Further, the fabricating procedure may further comprise: forming a planarization layer (OC), spacers (PS) on the color filter substrate by exposing process to planarize the BGR photoresist layer and maintain the cell thickness.

The embodiments of the present invention do not need to increase extra cost, and when the white light passes through the color filter layers constituted by (B+R), (B+G), and (R+G), the magenta M, the cyan C and the yellow Y are respectively displayed. This is equivalent to that each pixel region is constituted by six pixel units, so as to improve the color gamut of the display apparatus.

To sum up, compared with the existing pixel region constituted by using three primary color pixels, the embodiments of the present invention effectively improve the color gamut of the display apparatus, by arranging color filter layers comprising at least four colors in each pixel region.

Obviously, those skilled in the art may perform various amendments and modifications to the present invention, without departing the spirit and scope of the present invention. Thus, if these amendments and modifications of the present invention belong to the scope of the claims of the present invention and its equivalent technology, the present invention is intended to cover these amendments and modifications.

The present application claims priority from Chinese Patent Application No. 201310700382.4, filed on Dec. 17, 2013, the disclosure of the above Chinese Patent Application is hereby incorporated by reference in its entirety as a portion of the present application.

1. A color filter, each pixel region of the color filter comprising at least four pixel units, each pixel unit comprising a color filter layer, and the at least four pixel units comprising a first pixel unit, a second pixel unit, a third pixel unit and a fourth pixel unit, wherein a first color filter layer is formed in the first pixel unit, a second color filter layer is formed in the second pixel unit, a third color filter layer is formed in the third pixel unit, a fourth color filter layer is formed in the fourth pixel unit, and the fourth color filter layer is formed by stacking any two materials of the first, second and third color filter layers.

2. The color filter according to claim 1, wherein the two materials in the fourth color filter layer have a same thickness.

3. The color filter according to claim 2, wherein a thickness of the fourth color filter layer is the same as a thickness of at least one of the first, second and third color filter layers.

4. The color filter according to claim 1, wherein the fourth color filter layer is a cyan filter layer, the first color filter layer is a red filter layer, the second color filter layer is a green filter layer, the third color filter layer is a blue filter layer, and the cyan filter layer is formed by stacking a green filter layer material and a blue filter layer material.

5. The color filter according to claim 1, wherein the fourth color filter layer is a yellow filter layer, the first color filter layer is a red filter layer, the second color filter layer is a green filter layer, the third color filter layer is a blue filter layer, and the yellow filter layer is formed by stacking a red filter layer material and a green filter layer material.

6. The color filter according to claim 1, wherein the fourth color filter layer is a magenta filter layer, the first color filter layer is a red filter layer, the second color filter layer is a green filter layer, the third color filter layer is a blue filter layer, and the magenta filter layer is formed by stacking a red filter layer material and a blue filter layer material.

7. A display apparatus, comprising the color filter according to claim 1.

8. A fabricating method of a color filter, each pixel region of the color filter comprising at least four pixel units, each pixel unit comprising a color filter layer, and the at least four pixel units comprising a first pixel unit, a second pixel unit, a third pixel unit and a fourth pixel unit, and the fabricating method comprising:
forming a first color filter layer, a second color filter layer, a third color filter layer and a fourth color filter layer in the first pixel unit, the second pixel unit, the third pixel unit and the fourth pixel unit, respectively, wherein the fourth color filter layer is formed by stacking any two materials of the first, second and third color filter layers.

9. The fabricating method according to claim 8, wherein the fourth color filter layer is formed by stacking film layers having a same thickness and formed by any two materials of the first, second and third color filter layers.

10. The fabricating method according to claim 9, wherein a thickness of the fourth color filter layer is the same as a thickness of at least one of the first, second and third color filter layers.

11. The fabricating method according to claim 8, wherein forming the first color filter layer, the second color filter layer, the third color filter layer and the fourth color filter layer comprises:
forming a red filter layer in a region corresponding to the first pixel unit;
forming a green filter layer in a region corresponding to the second and fourth pixel units;
forming a blue filter layer in a region corresponding to the third and fourth pixel units, so that the region corresponding to the fourth pixel unit is formed by stacking the green filter layer and the blue filter layer.

12. The fabricating method according to claim 8, wherein forming the first color filter layer, the second color filter layer, the third color filter layer and the fourth color filter layer comprises:
forming a red filter layer in a region corresponding to the first pixel unit and the fourth pixel unit;
forming a green filter layer in a region corresponding to the second and fourth pixel units, so that the region corresponding to the fourth pixel unit is formed by stacking the green filter layer and the red filter layer; and
forming a blue filter layer in a region corresponding to the third pixel unit.

13. The fabricating method according to claim 8, wherein forming the first color filter layer, the second color filter layer, the third color filter layer and the fourth color filter layer comprises:
forming a red filter layer in a region corresponding to the first and fourth pixel units;
forming a green filter layer in a region corresponding to the second pixel unit; and
forming a blue filter layer in a region corresponding to the third and fourth pixel units, so that the region corresponding to the fourth pixel unit is formed by stacking the blue filter layer and the red filter layer.

14. The fabricating method according to claim 8, wherein the first to third color filter layers are formed through a full-tone region of a mask plate, and the fourth color filter layer is formed through a half-tone region of the mask plate.

15. The color filter according to claim 2, wherein the fourth color filter layer is a cyan filter layer, the first color filter layer is a red filter layer, the second color filter layer is a green filter layer, the third color filter layer is a blue filter layer, and the cyan filter layer is formed by stacking a green filter layer material and a blue filter layer material.

16. The color filter according to claim 2, wherein the fourth color filter layer is a yellow filter layer, the first color filter layer is a red filter layer, the second color filter layer is a green filter layer, the third color filter layer is a blue filter layer, and the yellow filter layer is formed by stacking a red filter layer material and a green filter layer material.

17. The color filter according to claim 2, wherein the fourth color filter layer is a magenta filter layer, the first color filter layer is a red filter layer, the second color filter layer is a green filter layer, the third color filter layer is a blue filter layer, and the magenta filter layer is formed by stacking a red filter layer material and a blue filter layer material.

18. The fabricating method according to claim 9, wherein forming the first color filter layer, the second color filter layer, the third color filter layer and the fourth color filter layer comprises:
forming a red filter layer in a region corresponding to the first pixel unit;
forming a green filter layer in a region corresponding to the second and fourth pixel units;
forming a blue filter layer in a region corresponding to the third and fourth pixel units, so that the region corresponding to the fourth pixel unit is formed by stacking the green filter layer and the blue filter layer.

19. The fabricating method according to claim 9, wherein forming the first color filter layer, the second color filter layer, the third color filter layer and the fourth color filter layer comprises:
forming a red filter layer in a region corresponding to the first pixel unit and the fourth pixel unit;
forming a green filter layer in a region corresponding to the second and fourth pixel units, so that the region corresponding to the fourth pixel unit is formed by stacking the green filter layer and the red filter layer; and
forming a blue filter layer in a region corresponding to the third pixel unit.

20. The fabricating method according to claim 9, wherein forming the first color filter layer, the second color filter layer, the third color filter layer and the fourth color filter layer comprises:
forming a red filter layer in a region corresponding to the first and fourth pixel units;
forming a green filter layer in a region corresponding to the second pixel unit; and
forming a blue filter layer in a region corresponding to the third and fourth pixel units, so that the region corresponding to the fourth pixel unit is formed by stacking the blue filter layer and the red filter layer.
